(19) United States
(12) Patent Application Publication
(10) Pub. No.: US 2004/0062340 A1
(43) Pub. Date: Apr. 1, 2004

(54) Self-regulating nuclear power module

(76) Inventor: Otis G. Peterson, Los Alamos, NM (US)

Correspondence Address: UNIVERSITY OF CALIFORNIA, LOS ALAMOS NATIONAL LABORATORY, P.O. BOX 1663, MS A187, LOS ALAMOS, NM, 87545, US

(21) Appl. No.: 10/630,111

(22) Filed: Jul. 30, 2003

Related U.S. Application Data
(63) Continuation-in-part of application No. 10/244,580, filed on Sep. 16, 2002.

(51) Int. Cl. G21C 3/56; G21C 19/28

(52) U.S. Cl. 376/383

(57) ABSTRACT

The present invention includes a nuclear fission reactor apparatus and a method for operation of same, comprising: a core comprising a fissile metal hydride; an atmosphere comprising hydrogen or hydrogen isotopes to which the core is exposed; a non-fissile hydrogen absorbing and desorbing material; a means for controlling the absorption and desorption of the non-fissile hydrogen absorbing and desorbing material, and a means for extracting the energy produced in the core.

### RELATED APPLICATIONS

This application is a continuation-in-part of application Ser. No. 10/244,580, filed on Sep. 16, 2002, by Otis G. Peterson, incorporated herein by reference for all purposes.

### STATEMENT REGARDING FEDERAL RIGHTS

This invention was made with government support under Contract No. W7405-ENG-36awarded by the U.S. Department of Energy. The government has certain rights in the invention.

### FIELD OF THE INVENTION

The present invention relates generally to nuclear power sources, and, more particularly, to nuclear fission power reactors.

### BACKGROUND OF THE INVENTION

It has long been recognized that the use of a fissile metal hydride as a nuclear fuel, such as uranium hydride, could potentially contribute to the stability of nuclear reactors because of the volatility of the hydrogen isotopes that contribute to the neutron energy moderation. However, it has not heretofore been understood that the basic characteristics of the hydride provide sufficient control of the nuclear reaction that external controls, such as neutron absorbing rods, are not required for stabilizing the reactor.

The present invention provides a compact reactor using such hydride characteristics to control and utilize nuclear fission energy in a new and different manner then previously attempted. A compact reactor can be economical and practical only if it is self-stabilizing and requires little or no active human control or monitoring. This present invention achieves control by utilizing the properties of a fissile metal hydride as a self-contained nuclear fuel and neutron energy moderator. If the physical size, fissile metal content and enrichment are appropriately selected, the metal will absorb ambient hydrogen, which moderates the neutron energies so that nuclear fission criticality is achieved. The temperature will then be increased by the fission reactions until the dissociation pressure of the hydrogen for that temperature is greater than the ambient pressure of the hydrogen, at which point the hydrogen dissociates from the hydride and the source becomes sub-critical. The dissociation pressure of the hydrogen is an exponential function of temperature so that small changes in temperature can initiate substantial hydrogen transport. Consequently, with the method and apparatus of the invention a dynamic equilibrium can be achieved where the temperature of the source is controlled by the ambient hydrogen pressure.

Various advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes a nuclear fission reactor apparatus and a method for operation of same, comprising: a core comprising a fissile metal hydride; an atmosphere comprising hydrogen or hydrogen isotopes to which the core is exposed; a non-fissile hydrogen absorbing and desorbing material; a means for controlling the absorption and desorption of the non-fissile hydrogen absorbing and desorbing material, and a means for extracting the energy produced in the core.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a pictorial representation of one embodiment of the present invention.

FIG. 2 is a pictorial illustration of one embodiment of a containment system of the present invention.

FIG. 3 is a graph of the relationship between K_{eff} and hydrogen content.

FIG. 4a is a graph of the initial response of the present invention reactor to a step function power transient.

FIG. 4b is a graph of the initial response of the present invention reactor to a gradual power transient.

FIG. 5 is a graph of dissociation pressure for uranium hydride as a function of temperature.

FIG. 6 is a graph of critical mass of U²³⁵ spherical and cylindrical geometries as a function of the H/U²³⁵ atomic ratio.

FIG. 7 is a graph of time dependence of diffusion controlled depletion of hydrogen from uranium hydride particles.

FIG. 8a is a graph of power decay if entire core is uranium hydride.

FIG. 8b is a graph of power decay if only 10% of the core is uranium hydride.

### DETAILED DESCRIPTION

The present invention is of a nuclear power reactor and method that is a dramatic departure from conventional reactor designs. The present invention is based on and takes advantage of the physical properties of a fissile metal hydride, such as uranium hydride, which serves as a combination fuel and moderator. The invention is self-stabilizing and requires no moving mechanical components to control nuclear criticality. In contrast with customary designs, the control of the nuclear activity is achieved through the temperature driven mobility of the hydrogen isotope contained in the hydride. If the core temperature increases above a set point, the hydrogen isotope dissociates from the hydride and escapes out of the core, the moderation drops and the power production decreases. If the temperature drops, the hydrogen isotope is again associated by the fissile metal hydride and the process is reversed.

The invention provides a novel technique for power generation and can compliment existing commercial power nuclear reactors. Extensive deployment of small nuclear power modules according to the invention can substantially improve our national energy independence. Each such unit would preferably generate modest thermal power (tens of megawatts) per unit and preferably operate at a maximum fuel temperature less than 800° C. Such nuclear power modules would be inherently fail-safe from over-temperature excursions and may be mass-produced as turnkey modules due to inherent design simplicity and compactness.

Of the difficulties nuclear energy has faced as an alternative to fossil fuels, primary among these have been high construction costs and safety related uncertainties associated with complex active control and safety systems. The present invention provides an alternative enabling power generation from compact sources at modest unit costs. The small size of the device limits investment risk, and the inherent control and safety characteristics, as well as inherent simplicity, allow the power modules of the invention to be economically competitive for commercial power generation. Small size (approximately one or two meters in diameter) and the absence of mechanical intrusions permit a device according to the invention to be sealed at the factory, sited underground, and eventually returned to the factory after a useful life of five or more years. Single unit, sealed construction and dispersed, underground siting also affords a significant level of anti-tampering and anti-terrorist protection.

Overall System Design

The reactor size has been evaluated for the purposes of these proof-of-principle calculations by assuming that the core volume is equally divided between fuel and the energy extracting heat pipes or cooling pipes. A system designed to generate useful power will require efficient extraction of the heat out of the system and therefore will need to have a significant volume of pipes protruding into the fissile volume. The quantity and density of heat extraction pipes is determined by the low thermal conductivity of the hydrogen isotope—fissile metal hydride mixture. This dilution of the fissile volume will increase the critical mass and volume necessary to sustain power production.

The reactor size is also affected by the enrichment of the fuel, with higher enrichments yielding smaller reactors. The optimum size will depend on economic and engineering considerations. The fissile hydride, in the most common embodiment, will be diluted with a fertile hydride, often composed of the same element as the fissile component, but of a different isotope. For example, a nuclear fuel comprising the fissile hydride U-235 typically also contains the isotope U-238. A nuclear fuel consisting of 5% U-235 and 95% U-238 is commonly referred to as a “reactor grade fuel”.

The power modules of the invention are based on the properties of a fissile metal hydride, hereinafter referred to as uranium hydride (UH₃) or hydride; specifically, the ease with which a hydrogen isotope, hereinafter referred to as hydrogen, can move in and out of the hydride. The device is self-stabilizing and requires no moving mechanical components to control nuclear criticality. This passive control is achieved by exploiting the mobility of the hydrogen within the uranium hydride, which is a self-contained nuclear fuel and neutron energy moderator. While uranium hydride has been demonstrated as a reactor fuel (G. A. Linenberger, et al., “Enriched-Uranium Hydride Critical Assemblies”, Nucl. Sci. & Eng. 7, 44-57 (1960)), it has heretofore been unknown to exploit the volatility of the hydrogen as a control mechanism for the fission activity.

The characteristics of uranium hydride that make it an ideal combination of fuel and moderator for a stable nuclear power source include: high density storage of hydrogen in the hydride matrix; powder formation as the hydride is formed from the metal; high diffusivity of the hydrogen through the hydride crystals; multi-atmosphere dissociation pressures at power source operating temperatures to assist in heat and gas transport; exponential dependence of the dissociation pressure on temperature to drive the hydrogen volatility; and low viscosity of the gas.

The small size of the core and the inherent safety characteristics of the modules of the invention come from the novel use of uranium hydride as a combination fuel and moderator. The hydride stores vast quantities of hydrogen, so much that the density of hydrogen in a given volume is equivalent to the density of hydrogen in water. This hydrogen, however, is volatile and easily dissociates from the uranium and diffuses out of the hydride by any increase in temperature. The resulting decrease in moderator density effectively inserts negative reactivity into the core. A decrease in core temperature reverses the process, i.e., causes hydrogen absorption, increasing the moderator density and therefore inserts positive reactivity into the core. The customary control of nuclear power devices by the mechanical insertion (removal) of control rods is thus replaced by the self-regulating, temperature-driven desorption (absorption) of the moderating hydrogen. The complex arrays of detectors, analyzers and control systems responsible for the safety and stability of conventional nuclear reactors are supplanted by the fundamental science and properties of the active materials in the present invention.

Effective gas transport for reactivity control requires the unit volumes to be small. However, even at this small size, these modules may be economically competitive because their inherent safety and stability may permit simplified system engineering, autonomous operation, and the mass production of turnkey devices.

Metal hydrides, including uranium hydride, are unusual compounds that can exist with a continuous range of hydrogen-to-metal atom ratios up to the stoichiometric value for the compound, i.e., 3 to 1 for UH₃. The advantages inherent to the hydride include high density storage of hydrogen, powder formation as the hydride is formed, stability of the powder phase up to high temperatures (900° C.) (John F. Laker, “Isotherms for the U-UH3-H2 System at Temperatures of 700°-1050° C. and Pressures to 137.9 Mpa”, University of California Radiation Laboratory (UCRL)-51865 (1975)), high diffusivity of the hydrogen through the hydride, multi-atmosphere dissociation pressures at power module operating temperatures, and exponential dependence of the dissociation pressure on temperature to drive the hydrogen volatility. The powder formed by hydrogen absorption into metallic uranium has a measured density of 7.5 gm/cm³, G. A. Linenberger, et al., “Enriched-Uranium Hydride Critical Assemblies”, Nucl. Sci. & Eng. 7, 44-57 (1960), and is comprised of particulates that are less than 75 microns in diameter, James S. Church, “Uranium Hydride Fabrication”, Los Alamos Manuscript (LAMS)-872, Quarterly Report (Mar. 15, 1949).

The small size of the hydride particles permits the hydrogen to diffuse out of these particles very rapidly. This diffusion time constant was calculated numerically for the largest particle observed, 75-microns, and found to be approximately 30 to 40 milliseconds. In addition to such advantageous physical characteristics, the compound is also highly reducing chemically: a dramatic departure from nuclear fuels in common use. This unusual chemistry can make fuel reprocessing and actinide recovery as straightforward as a few zone-refining runs.

A critical mass of the hydride fuel composed of reactor grade uranium (5% enriched in U²³⁵) has been evaluated from literature data and by running the Monte Carlo neutron transport code, MCNP. See J. F. Briesmeister, Ed., “MCNP-A General Monte Carlo N-Particle Transport Code”, Version 4C, Code Manual LA-13709-M, Los Alamos National Laboratory (2000). The physical characteristics of a simple critical sphere are listed in Table 1 under the “Bare Core” column. The characteristics of a practical device in which one half of the volume contains heat pipe material and the other half hydride fuel is listed under the “Half Heat Pipes” column.

TABLE 1

| Core Property | Bare Core | | Half Heat Pipes | |
|---|---|---|---|---|
| U²³⁵ enrichment | 4.94% | | 5% | |
| Power Production | 5 | MW | 50 | MW |
| UH₃ crystal density | 11 | g/cm³ | 11 | g/cm³ |
| UH₃ powder density | 7.5 | g/cm³ | 7.5 | g/cm³ |
| Void fraction | 0.32 | | 0.32 | |
| U²³⁵ critical mass | 30 | kg | 215 | kg |
| Total critical mass | 607 | kg | 4.3 | MT |
| Critical volume | 83 | liters | 1153 | liters |
| Critical diameter | 54 | cm | 1.2 | m |
| Energy content | 78 | MW years | 540 | MW years |

| | | |
|---|---|---|
| Number of Heat Pipes | Zero | 1660 |

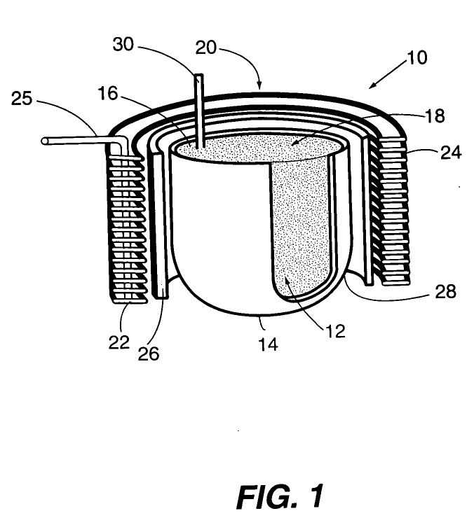

FIG. 1 is a pictorial illustration of one embodiment of the present invention reactor 10, which shows power module 12 to be a hemispherical volume on bottom 14 and topped with cylindrical volume 16 of equal diameter. Top surface 18 of the powder is approximately flat and open to hydrogen atmosphere 20, which allows the hydrogen to flow in and out of power module 12.

Also diagrammed outside core 12 is a collection of trays 22 to hold nonfissile hydrogen absorbing material 24 (preferably another hydride) to absorb the hydrogen expelled from the core. The preferred storage material is depleted uranium whose chemistry is substantially identical to the fissile material or alternatively thorium, another actinide that is chemically similar and has a hydride dissociation pressure very close to that of the fissile uranium. The reactor and hydrogen storage volumes are separated by insulator/reflector 26 to dampen thermal feedback, as well as reduce neutron leakage. A simple insulator for this application could be a stainless steel evacuated chamber. Reactor core vessel walls 28 may also include a solid (e.g., beryllium or stainless steel) neutron reflector (not shown) to reduce the critical mass.

The temperature of the storage media determines the hydrogen pressure within the sealed chamber by either absorbing or desorbing the gas. The ambient hydrogen pressure, in turn, fixes the effective temperature of the core by causing absorption of hydrogen by the core if the core temperature is below the dissociation temperature for that pressure and causing dissociation and diffusion of hydrogen away from the core if the core temperature is above the dissociation temperature.

Under normal operating conditions, startup procedures for the power module include employing temperature controllers (not shown) for raising the temperature of the hydrogen storage trays to dissociate stored hydrogen from the storage media for absorption by the core. When the concentration of hydrogen in the core reaches the critical value, the reactor will generate fission energy and the core will rapidly increase in temperature. As the core temperature passes the storage temperature, the flow of hydrogen reverses and the core temperature stabilizes. Likewise, the system can be shut down by cooling these trays so the storage media will absorb hydrogen, effectively extracting hydrogen from the core. The core temperature is thereby fixed in value independent of the power extraction, allowing for beneficial load following characteristics, an obvious system advantage.

There are many configurations for controlling the temperature of the trays of hydrogen storage hydride material. These include elongated structures, for example heat pipes 25 illustrated in FIG. 1, installed for this explicit purpose and fluid flow systems. It would not be appropriate to use any hydrogenous fluid, e.g., water, for this purpose because of the necessity to prevent such fluids leaking into the reactor chamber and increasing the quantity of hydrogen therein. The heating and cooling of these trays of hydrogen storage material control the reactor. The cooling capacity must be sufficient to remove the chemical energy released by the absorption of the hydrogen into the storage media.

In one embodiment, heat is extracted from the fissile volume with liquid metal heat pipes or nonhydrogenous-fluid cooling tubes. A single such exemplary heat pipe 30 is illustrated in FIG. 1. The use of liquid metal heat pipes contributes to the system's passive safety by eliminating the need for mechanical pumps (and the concomitant potential for mechanical failure of such pumps) to transport the thermal energy out of the fuel. The liquid metal does not introduce any non-volatile moderation as would water cooling. Further, the heat pipes can be designed to provide suitable redundancy and overcapacity in addition to fail-safe cooling to dissipate energy generated by the decay of radioactive fission products. An actively pumped cooling system employing a nonhydrogenous fluid would be equally effective in implementing the transfer of heat from the core to a heat exchanger for subsequent generation of electricity. The active system would preferably have redundant pumping capacity to insure cooling continuity.

The heat pipe cooling system, as described above, is adequate for almost all contingencies. To manage the possibility that the primary cooling system might fail, a secondary cooling capability may be provided to extract from the heat pipes the power produced by the radioactive decay energy stored in fission fragments. Such radioactive decay energy starts at 7 or 8% of the operating power of the reactor but rapidly decays from that value. A conservative approach to total system safety may motivate the installation of an independent cooling system for the “pot” that contains the hydride. This third level of heat extraction would protect the uranium container from any possibility of catastrophic damage that may be envisioned if the stored energy could raise the powder temperature to the melting temperature of uranium metal.

There are several choices for alternate cooling or energy extraction systems instead of the proposed heat pipes that might afford equivalent or possibly even greater benefits. These include active fluid flow systems of liquid metals, or alternatively inert or noble gases, atomic or molecular. The important selection criterion is that any coolant fluid be non-hydrogenous, so as not to add any nonvolatile neutron energy moderation to the system. An additional constraint is the use of a fluid with minimal neutron absorption so as not to increase the critical mass of the reactor. The preferred liquid metals for heat transfer include sodium, potassium and their mixture, NaK. Atomic or noble gases could be employed, preferably helium or argon. Molecular gases have higher heat capacities than atomic gases and examples of these would be nitrogen and carbon dioxide. Essentially all of these fluids have been effectively employed in reactors at some time.

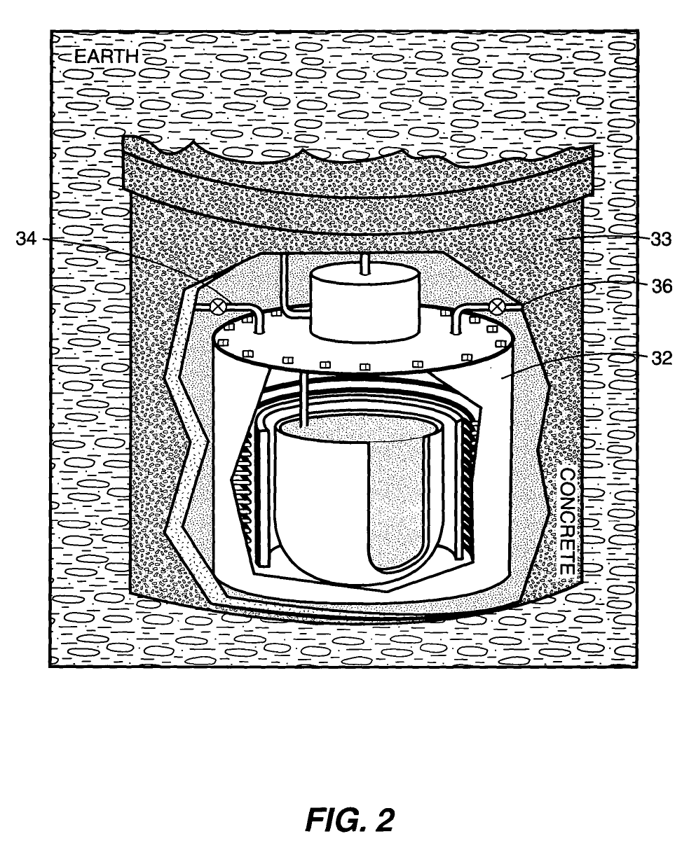

FIG. 2 further illustrates the outside containment vessel 32 that confines the hydrogen gas and underground vault 33 that provides shielding for the external environment. This containment vessel is preferably sealed at the factory except for a plurality of small gas ports 34,36. Such gas ports allow for pressurization/depressurization of the vessel with hydrogen and permits periodic maintenance of any contained gases. Fission product gases (non-essential reactor byproduct gases), such as neutron absorbing (fission poison) Xenon and other fission fragment gases, can be removed and hydrogen added to replace hydrogen that is lost to diffusion out of the container. Also, the power module can be made completely safe from inadvertent nuclear startup by evacuating most of the hydrogen out of the chamber through these ports, thereby removing the moderation required for criticality.

Because of the compact design, the entire reactor module and containment vessel can be designed for removal from the vault and return to the factory at the end of its useful life. In such a scenario, it is preferred that the reactor vault and shielding be a permanent structure, such that only the power module and its containment vessel are replaced. Because of the small size of the module, it is expected that the vault containing the module will be sited underground so that most of the radiation shielding will be the local earth. The low cost of the shielding is another economic advantage of this invention.

Reactor Core Design

Neutron multiplication in the module is regulated by a highly sensitive moderator feedback coefficient. An initially positive reactor period can be rapidly reduced by the hydrogen bubbling out of the core, desorbed from the particles due to the rise in temperature. However, the recovery from a negative reactor period must be more gradual due to the slower pressure-induced transport of the hydrogen into the powder for its re-absorption into the particles. Therefore, a dynamic equilibrium of the core criticality can damp out after a small number of oscillations.

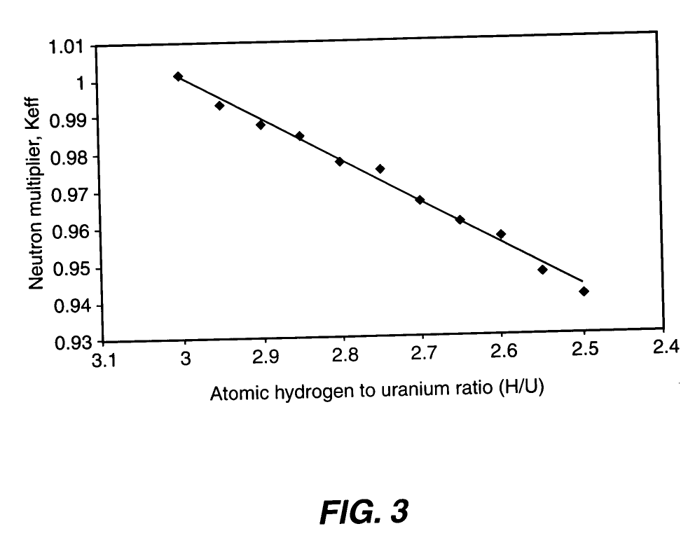

The MCNP code was employed to quantitatively evaluate the reduction in the neutron multiplication factor, K_{eff}, by the loss of moderation due to hydrogen depletion. This code was used to determine the functional relationship between K_{eff} and the hydrogen content since the function was not found in the experimental research literature. Experiments customarily have been performed with a constant density moderator, water, and variable densities of fuel instead of the opposite as required for this application. This multiplication factor, K_{eff}, was evaluated and found to change about 3.4%, equivalent to about $4.70 of negative reactivity, when the hydrogen density dropped 10%. The functionality is displayed in FIG. 3, which also shows the individual points that were calculated to determine the function. This calculation was simplified by assuming that the hydrogen was uniformly depleted throughout the core.

Under normal operation the control of the criticality of the reactor requires hydrogen mobility that is equivalent to the depletion of only a few tenths of a percent, which is equivalent to a few millimeters of hydride in a one-meter core. The change in hydrogen content of 0.03% translates into a change in the value of the neutron multiplier, K_{eff}, of one part in 10⁻⁴.

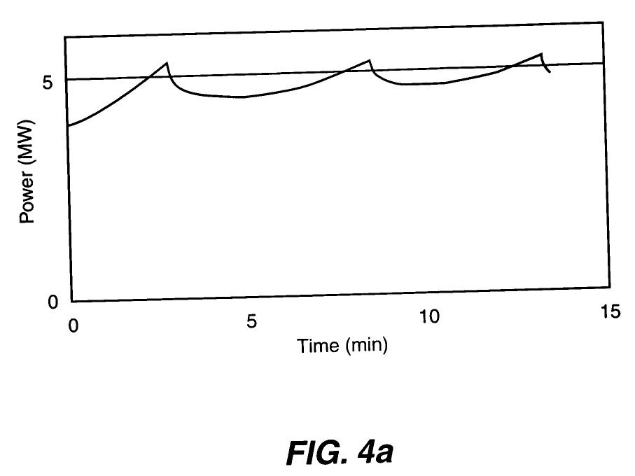

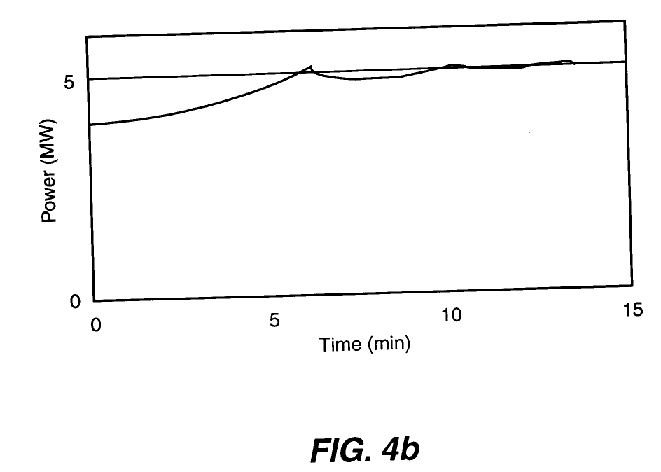

Neutron multiplication in the module is regulated by a highly sensitive moderator feedback coefficient. An initially positive reactor period (rate of neutron increase) can be rapidly reduced by the hydrogen desorbing and bubbling out of the core, due to the rise in temperature. However, the recovery from a negative reactor period (rate of neutron decrease) must be more gradual due to the slower pressure induced transport of the hydrogen into the powder volume. Referring to FIG. 4, results of numerical model calculations indicate that the initial response of the reactor to power transients will be mild oscillations that dampen out under proper conditions.

The effective steady-state temperature of the core is controlled by the ambient hydrogen gas pressure, which is controlled by the temperature at which the nonfissile hydrogen absorbing/desorbing material is maintained. The temperature of the fissile volume therefore is independent of the amount of power being extracted (load following). The power output is dependent only on the ability of the heat pipes and heat exchanger to extract the power from the module.

There are several characteristics inherent to uranium hydride that contribute to the stability of reactors based on this material. The high mobility of the hydrogen, both within the hydride and throughout the active volume, creates the system stability. The addition of hydrogen to uranium metal makes it very brittle and the material rapidly turns to powder. Furthermore, this powder is stable, not fusing together until over 900° C. (John F. Lakner, “Isotherms for the U-UH₃-H₂ System at Temperatures of 700°-1050° C. and Pressures to 137.9 MPa”, UCRL-51865 (1975)). The small size of the particles is advantageous because it permits rapid diffusion of the hydrogen out of the particles and therefore rapid response of the reactor to changes in temperature. Most of the gas is expected to escape from the volume by fluidizing the powder and ultimately pushing the powder aside and bubbling through the powder to the surface. As noted earlier, the diffusion rate out of a single large particle has been evaluated for the experimentally measured maximum particle size (75 microns in diameter) and found to be approximately 30 to 40 milli-seconds.

The temporal response of any nuclear reactor is controlled by the relatively long lifetimes of the small fraction of delayed neutrons that are emitted by the fission products. The termination of nuclear activity, as necessary to control the system temperature, is dependent on the rate at which this delayed neutron emission decays and the rate at which the system criticality can be reduced. Each of these phenomena that affect the stability of the system has been evaluated quantitatively but within the context of an example critical assembly.

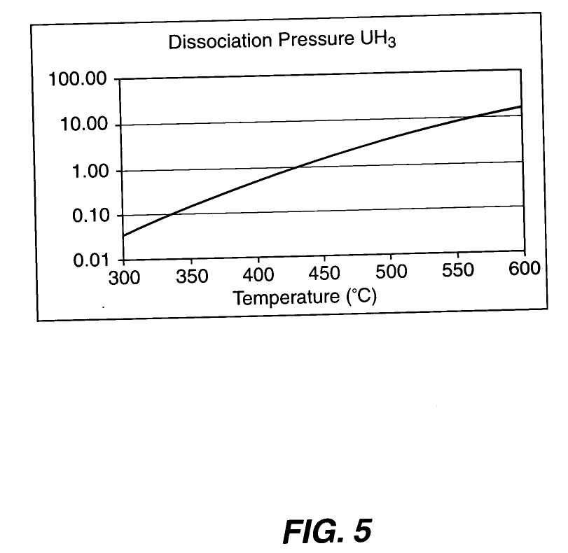

The invention is preferably limited in operation to the temperature range from approximately 350° C. to 800° C. for UH₃ based fuel, where the dissociation pressure, shown in FIG. 5, of the hydride is in the range that permits efficient gas transport. The data comes from “The H-U System,” Bulletin of Alloy Phase Diagrams, 1, No. 2 (1980), pp. 99-106. This temperature range is fortuitous because it includes the near optimum temperature for operation of steam boilers, i.e., the mid-500° C. range. Samuel Glasstone, Principles of Nuclear Reactor Engineering, D. Van Nostrand Co. (1955), §1.24.

While MCNP was used to evaluate the critical mass of the reactor configurations, these calculations were verified using the following scientific literature. H.C. Paxton et al., “Critical Dimensions of Systems Containing U²³⁵, Pu²³⁹, and U²³³,” Los Alamos Scientific Laboratory and Oak Ridge National Laboratory Report TID-7028 (June 1964), have compiled extensive data on uranium criticality, mostly from experiments using highly enriched uranium diluted with water moderator.

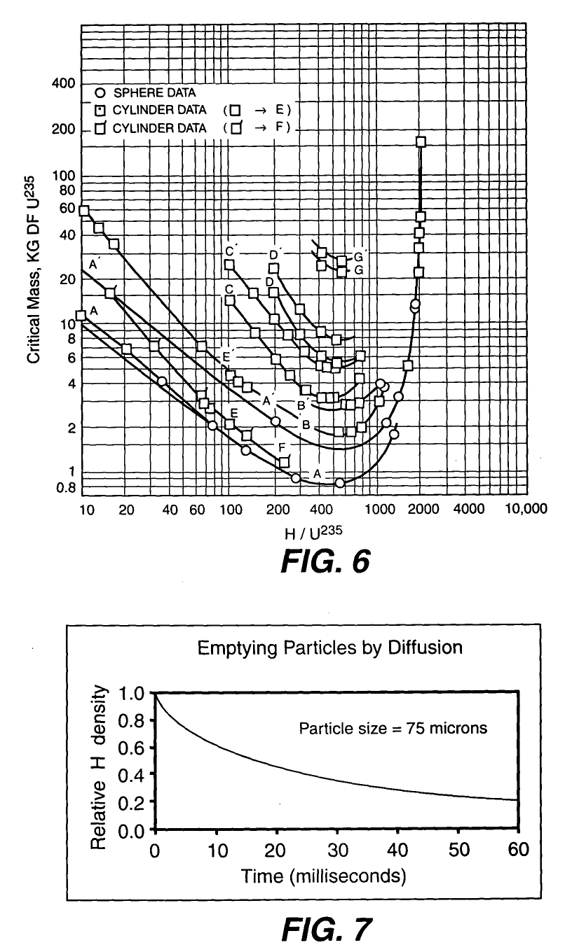

The critical mass has been evaluated as a function of the density of the fissile uranium 235 in a water moderator and is plotted as a function of the ratio of H to U²³⁵ for several values of enrichment in FIG. 13 of the reference, which is reproduced as FIG. 6 of the present application. All geometries include neutron reflectors, either water or paraffin; Curve A shows U(93)O₂F₂ solutions and U(95)F₄—CF₂—CH₂; B shows U(4.9)O₂F₂ solutions; C shows U₃(4.9)O₈—C₂₁₀O₆;D shows U(2.0)F₄—C₂₅H₅₂; E shows U(37)O₂F₂ solutions and U(37)F₄—CF₂—C₅H₈O₂;F shows U(29.8)F₄—CF₂—CH₂; and G shows U(1.42)F₄—C₄₀H₈₁.

The “C” curve for 4.9% enriched uranium is the most appropriate for estimating the critical mass for this device. The line from 15 kg past 30 kg has been extrapolated from the published data and the critical mass for the hydride power source can be estimated from this extrapolation to be approximately 30 kg of U²³⁵ for the H to U²³⁵ ratio of 61, which is characteristic of UH₃ enriched to 4.9%. This value is approximately double the critical mass measured for 93% enriched uranium hydride: G. A. Linenberger, et al., “Enriched-Uranium Hydride Critical Assemblies,” Nuclear Science and Engineering: 7, 44-57 (1960).

The experiments by Linenberger, et al., were performed on blocks of UH₃ that were fabricated from powdered UH₃ held together with a polymeric binder. Since the powder was bound up with the polymer, no experiments could be performed to investigate the self-stabilizing potential of the UH₃ powder, active material. The critical masses measured by Linenberger, et al. were all approximately 13.6 kg of the 93% enriched uranium for assemblies using neutron reflectors to reduce the required mass. The factor-of-two difference between the masses of U²³⁵ required to achieve criticality depending on the enrichment of the active material is consistent with other data published in Paxton et al., supra.

The physical dimensions of a practical device will depend on many important engineering factors and can be purposely manipulated in many ways. The limited thermal conductivity of the fuel dictates a high density of heat extracting pipes or tubes. The fuel enrichment will significantly affect the core size, with greater enrichment decreasing the size and lesser enrichment increasing the size significantly. In addition, the isotopic content of the hydrogen gas can be manipulated to increase the size of the core. Deuterium is less effective at neutron energy moderation than is protium, therefore, adding deuterium to the gas will increase the required core size. This characteristic can also be employed to increase the useful lifetime of a single load of fuel by doing the initial moderation with a high concentration of deuterium and progressively replacing the deuterium with protium. In this manner, the decrease in fissionable material is counterbalanced by the increase in moderation effectiveness.

Neutron Flux Transient Response

The transient response of the reactor is dependent on the hydrogen content and its flow in and out of the reactor core. A period of positive reactivity with increasing power production will be terminated only after the power has overshot the value that can be extracted. The excess power that is produced will raise the temperature of the critical volume, triggering the dissociation of the hydride into metal and hydrogen gas. The amount of energy required to dissociate all of the hydrogen in a volume of uranium hydride powder is 4.3 kJ/cm³. At the rate of power production assumed for the reactor, 50 to 100 W/cm³, the time to deplete a given volume would be 86 to 43 seconds. During this time the temperature of the volume would be held approximately constant, as the power would go into dissociating the molecules and not into heating the volume, similar to phase transitions.

A period of negative reactivity with decreasing power production will start as soon as enough hydride has been dissociated to reduce the K_{eff} below 1.0, i.e. a condition less than critical. The period of negative reactivity will last until hydrogen has been forced into the core by external pressure to bring the moderation back up to critical, i.e. where K_{eff} is again 1. Under the right conditions this oscillatory behavior will continue for a short time before being damped out by the inherent disparity between the rates of inflow and escape of the hydrogen gas, as graphically shown in FIG. 4b.

The numerical calculation for the neutron flux, and proportionately the reactor power, can be separated into several components within each time step and then repeated for each of these small time steps. It is assumed that the transient of concern is generated by a relatively rapid buildup of neutron flux as the reactor increases power production. The reactor power production is increased by extracting more heat from the core than is being generated. The extra heat extraction cools the core below its stable temperature as fixed by the ambient hydrogen gas pressure. A drop in core temperature will reduce the dissociation pressure within the core, driving more hydrogen into the reactor. The increase in hydrogen content increases K_{eff} according to the function presented above. This small increase in K_{eff} will increase the neutron flux and also the precursors for the delayed neutron production.

The critical equation for the neutron flux, Φ, as presented in Samuel Glasstone, Principles of Nuclear Reactor Engineering, D. Van Nostrand Co. (1955), within a reactor is:

1dΦ/dt=[K_{eff}(1−β)−1]Φ+ΣᵢCᵢ/τᵢ

where 1 is the neutron lifetime, β is the total fraction of delayed neutrons that are emitted following fission, and Cᵢ is the effective concentration of fission products that emit delayed neutrons of decay time τᵢ. For uranium²³⁵ the value of β is 0.73%. The effective values of the fission product concentrations can be evaluated from the following differential equation:

dCᵢ/dt=βᵢΦ−Cᵢ/τᵢ,

where βᵢ is the fraction of neutrons with the decay time of τᵢ. The decay lifetimes range from 0.33 sec to 81 sec.

These coupled differential equations cannot be solved analytically in a simple form. However, if we make a few assumptions, they can be solved with a combination of analytical and numerical methods. A convenient size for a single numerical step is approximately one second or a fraction of a second. The ratio of the neutron lifetime, approximately 7 μsec., to the time step is then about 10⁻⁴. The change in the neutron flux over the time step is also small, so the differential term in the equation can be ignored and the neutron flux approximated by the following equation:

$$ϕ = \frac{1}{1 - {K}_{eff} ( 1 - β )} {\sum }_{i} \frac{{C}_{i} ( t )}{{τ}_{i}}$$

For each step in the numerical calculation the populations of each precursor family is calculated assuming the neutron flux has the constant value it had at the beginning of the time step. A new value for the neutron flux is then calculated from these population values. Other system parameters are then calculated from this flux or from independent inputs. The other important parameters include gas flow characteristics, hydrogen content within the core, and core temperature and hydrogen pressure. The K_{eff} in these equations is evaluated from the hydrogen content using the MCNP calculations described above. The cycle of calculations is repeated as many as a thousand times to predict the temporal behavior of the reactor.

Hydrogen Transport

Under normal operating conditions only a fraction of a percent of the hydrogen stored within the core will be exchanged between the core and storage media to maintain equilibrium. If the system temperature starts to rise because of a sudden decrease in power extraction, even including catastrophic coolant failure, the escaping hydrogen will push the powder aside, bubbling up to the surface. The gas will ultimately bubble out since the gravitational pressure head of powder is less than the pressure required to force gas flow through powder. At the very first, a depletion wave will start on the top surface of the powder and progress down through the volume. Above the front of this wave, the rate of hydrogen depletion will be limited by the diffusion of the gas out of the hydride particles, and below the front the weight of the particles will maintain the gas at the dissociation pressure, preventing gas from escaping from that volume.

Following this initial transient, the rate at which the gas is driven out of the core will be limited by the fission power being produced that is in excess of what can be dissipated by the heat pipes. The power required to dissociate the hydride is 4.3 kJ/cm³. The power driven gas evolution will be volumetric but all of this gas must escape out of the top surface. The volumetric gas flow will linearly increase in the vertical direction. For large enough power transients this gas flow will exceed the threshold for fluidization of the powder at some position within the powder. Above this transition position, the powder density will be diminished and above that bubbles will form to transport the gas swiftly through the powder. For the purposes of the modeling calculations, it is assumed that the resistance to gas flow by the generation of bubbles is negligible.

The escaping hydrogen gas must have a large volume pathway to the storage medium to ensure a minimum of pressure gradient to promote the flow. The storage material must be dispersed over a large number of trays to present a vast surface area to the gas volume to absorb the excess hydrogen in a time scale comparable to the bubble assisted escape from the core.

Filling the core with hydrogen is a much slower process than the escape since the gas must be forced into the volume by pressure induced flow through powder. The disparity between these two phenomena is another significant advantage of uranium hydride since it can introduce damping into the transient behavior of the reactor. The reformation of the hydride requires a pressure differential to force the gas into the core. The replenishment of the hydride will start on the surface of the powdered fuel and proceed until the surface layer is saturated. The layer of saturation will then progress into the fuel volume. It is assumed that the initial escape of the gas left the hydride throughout the volume a few percent below saturation. The production of the hydride will then result in saturated hydride near the surface with the remaining volume slightly depleted.

To continue the production of hydride, the gas must be transported across the saturated layer into the region of depleted hydride. The gas flow calculations require knowledge of the pressure difference across the saturated layer and the width of that layer. Using these parameters and the properties of the powder, the flow rate through the power can be calculated using the equations as presented in I. E. Idelchik, “Handbook of Hydraulic Resistance”, 2^{nd} Ed., Hemisphere Publishing Corp. (1986):

$$\begin{matrix}Δ P = ( \frac{ρ {v}^{2}}{2} ) \frac{1.53}{{ϵ}^{4.2}} \frac{λ l}{d} , \\ where λ = \frac{75}{Re} + \frac{15}{\sqrt{Re}} + 1 , \\ and Re = \frac{0.45}{( 1 - ϵ ) \sqrt{ϵ}} \frac{vd}{υ} .\end{matrix}$$

In these equations ΔP is the pressure head, p is the gas density, v is the gas velocity, ε is the void fraction (0.32) in the powder, l is the width of the saturated volume through which the gas must be forced into the core and d is the average particle size (6 micron). Re is the Reynolds number in which u is the viscosity of the hydrogen gas. For the purposes of the numerical calculations, the Reynolds number for one step in the calculation is used to evaluate the gas velocity within the next step and the Reynolds number subsequently updated.

During periods of negative reactivity, the heat extraction from the core can dramatically reduce the core temperature and therefore the gas pressure. A simple assumption of constant power extraction from the core would reduce the temperature and pressure to levels that are not physically believable. The technique for heat extraction that appears most attractive is alkali metal, e.g. potassium, heat pipes. Such devices do not contribute any non-volatile moderation to the core, as would be the case for any hydrogenous cooling fluid. Heat pipes have very distinct temperature dependent power transport properties. In the low temperature portion of their operating range, the transport is dependent on the vapor pressure of the working fluid. The power extraction increases with temperature up to a saturation level that is dependent on the sound velocity of the gaseous fluid. In the system modeling this functionality of the heat pipes has been applied to the heat extraction to limit the range of temperature and pressure excursions to values more connected to reality.

In an example numerical simulation, the core temperature dropped about 40 or 50° C. and the core pressure dropped about 4 atmospheres from a starting pressure of 8 atmospheres. Such a pressure difference is certainly adequate for pushing the hydrogen into the core to regenerate the hydride required for moderation of the fission activity.

All of these considerations have assumed that the diffusion out of the hydride particles is rapid. This diffusion rate for the largest particles in the powder, 75 microns in diameter, has been calculated numerically using the best available value for the diffusion constant D=1.9×10⁻⁶ exp (−5820/T) (m²/s). FIG. 7 shows the temporal decay of the hydrogen content in the 75-micron diameter particle. The relative concentration drops to the 1/e value in 33 milliseconds and the long term decay time constant is 38 milliseconds. The conservative value for the diffusion time for the large particles was 40 milliseconds, which is three orders of magnitude faster than is required to supply the hydrogen gas expelled during a loss of coolant accident, as will be shown below. This evaluation takes advantage of the fact that the gas expulsion is a volumetric process. Since the gas absorption process takes place along a moving front within the volume of the powder, the diffusion time may have a more significant effect in limiting the rate of absorption.

As discussed previously, it is anticipated that a compact reactor according to the invention will be assembled and fueled at a factory and shipped to its installation point as a sealed unit. During fuelling and shipping, only inert gases will be allowed to come into contact with the fuel. After the final installation has been completed, the inert gas will be evacuated and the appropriate quantity of hydrogen admitted into the sealed chamber. The admission of the hydrogen is controlled to insure that the correct quantity is admitted. An overfilling of the chamber with hydrogen could defeat the inherent safety features of the reactor by saturating both the core and storage media. Preparatory to the return shipment of the reactor to the factory, the bulk of the hydrogen will be evacuated from the chamber and the chamber over-pressurized with inert gas to eliminate all possibilities for further nuclear reactions and to prevent the inadvertent admission of oxygen.

Simulation of a Reactor Transient

The transient response of the reactor can be evaluated within the assumptions and conditions discussed above. To simplify the calculations, the bare core geometry with no heat pipes was assumed. The calculation was started assuming that the reactor was operating at a power level of 4 MW and the power extraction was increased to 5 MW. The initial transient response was calculated assuming a step-function change in the heat extraction and is displayed in FIG. 4. It is seen that the power builds slowly from its initial value, overshoots the new set point but quickly turns around. The resulting oscillations are unsymmetrical but show little tendency to damp out. It is seen that the positive period region is very short in time and the excess power produced reaches less than 10% of the stable value. The negative periods are much longer and the power swings slightly greater.

A step-function change in heat extraction is not physically achievable and is excessive in its effects on the dynamics of the system. Limiting the rate at which the cooling of the core can progress is much more realistic and permits the transient effects to rapidly damp out. The two types of system behavior are displayed in FIGS. 4a and 4b. The limits to the rate of change of system parameters that permit damped oscillations in power include: changes of no more than 10% in the power production within a 5 minute time interval and no more than a 2° C. change of core temperature per minute. While these limits on the rate of change of input parameters appear to be restrictive, they are compatible with the requirements for steady power production characteristic of commercial power production. If fact, these rates of change are far more rapid than are ever expected of large gigawatt power production facilities.

The power oscillations that were observed were caused by oscillations in the hydrogen concentration and resulting K_{eff}. In the case where these oscillations were rapidly damped, the oscillations in hydrogen content were found to change by less than 2 tenths of one percent and the resulting changes in K_{eff} reached a maximum of just over 10⁻⁴ at only one time during the simulation. The disparity between the length of time the system spends above and below the set point is clearly due to the differences between the phenomena that control the gas flow in the two regions of operation.

Inherent Stability from Coolant Loss

To justify minimal operational oversight, this reactor must be demonstratively safe in the event of a worst-case accident: complete loss of coolant during full power operation. The response of the device to such circumstances has been modeled, again for the bare core with no cooling tubes. A reasonable power production for the bare core reactor is 5 MW thermal. The effects of this sudden disappearance in cooling capacity have been evaluated numerically with the same rate equations as used above to calculate the transient response of the reactor. Applying the full power of the reactor to the dissociation of the hydride drives off large quantities of hydrogen in a short period of time. The consequent reduction in moderation depresses the neutron flux reducing power production and the rate of production of precursors for delayed neutron emission. The reactor is shut down in a very short period of time.

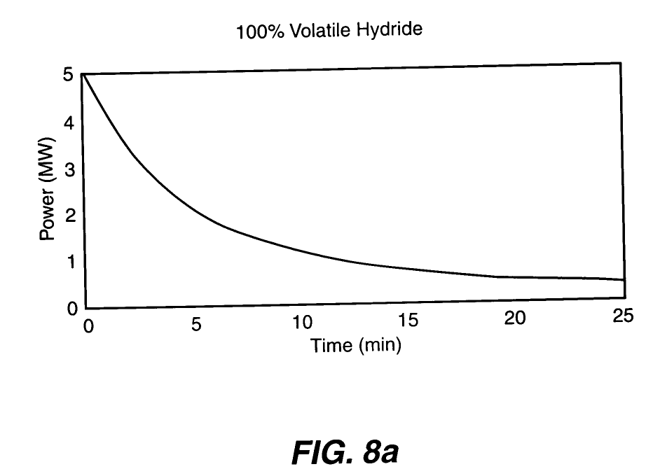

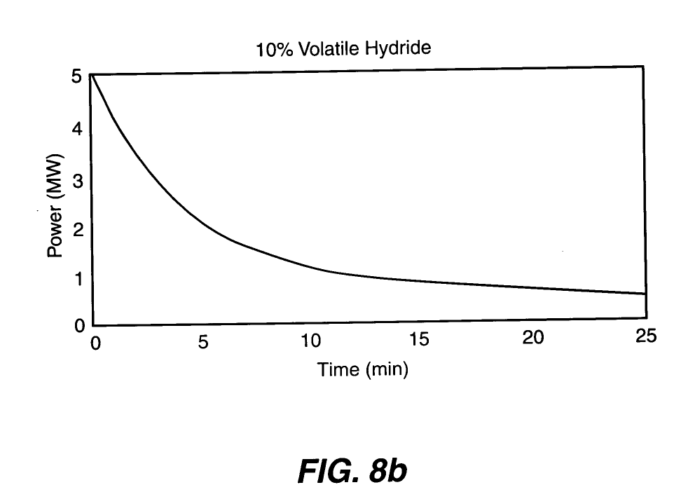

An attractive design would quench the fission power production down to the power production of the radioactive fission fragments before the hydride had been all dissociated. If the entire core is uranium hydride this criteria is satisfied as is shown by the power decay displayed in FIG. 8a. Artificially limiting the fraction of the core that is volatile demonstrates that almost equivalent results are obtained if at least 10% of the core is volatile hydride. The power curve for the 10% volatility case is displayed in FIG. 8b. As is evident, the two curves are remarkably similar. The conclusion is that reactor designs should allow for dissociating at least 10% of the hydride and having the capacity to absorb at least that quantity of released hydrogen.

Impurity Effects

There is a concern associated with impurities. There is possibility of hydride powder particles fusing together, due to increased impurities as a result of fission byproduct elements, lowering the overall melting temperature of the hydride. This would slow down the diffusion of hydrogen out of the hydride particle. An illustrative example is plutonium creation. Plutonium is created from U-238 by the phenomenon of neutron capture Because of plutonium's lower melting temperature than uranium, the hydride particle melting temperature will decrease accordingly as plutonium is created. However, the phase diagram for mixtures of uranium and plutonium have been well studied and the melting temperature of nearly pure uranium drops only 11° C. for each one percent of added plutonium. Such a small variation in melting temperature has no significant effect on the potential fusion of the particles. Since the fission fragments are statistically distributed over a number of elements, the concentration of any single element should never exceed 0.2%. Therefore, although impurities will be introduced, they will not have a detrimental effect on reactor operation within the temperature range of preferred operation.

Reactor Operation: Startup/Shutdown

Under normal operating conditions, the power module is started up from a standby or low power operation by raising the temperature of the hydrogen storage trays to drive stored hydrogen over to the core. Similarly, the system is shut down or put into standby by cooling these trays so they will absorb hydrogen, extracting it from the core. Under equilibrium operation, the core temperature is slaved to the storage tray temperature. When the module is producing significant power, the storage tray temperatures must be raised significantly to keep hydrogen in the hydride volumes affected by the temperature gradients that extract power from the fuel. This characteristic generates an additional safety feature: the storage trays must be maintained at a temperature elevated above the average temperature of the fuel. This prevents the core from inadvertently heating the storage volume thereby releasing hydrogen and generating runaway fission.

The modules are initially started after installation at their operating site by the carefully monitored addition of hydrogen into the sealed chamber. This will generate the required hydride from the metallic powder already installed into the core during module manufacturing. To promote the hydride forming reaction, the core and storage trays will need to be raised to the 200° C. temperature region. Making the storage component temperatures higher than the core will ensure that the hydrogen fills the core first. At the first indication of fission, the hydrogen transfer will be terminated. Stable and safe operation of the reactor requires that the chamber contain only enough hydrogen to bring the core up to criticality, leaving the storage media almost completely empty of hydrogen. The storage material must have the capacity to absorb massive volumes of hydrogen in the event of any over-temperature excursions of the core and therefore under normal conditions must be substantially empty. Stable operation of the module will require a minor surplus of hydrogen, which can be finely adjusted as the reactor starts power production. Periodic maintenance of this hydrogen reserve will be required to make up for the minor but continual loss of hydrogen to diffusion through the container walls.

Permanent shut down and safety from any further fission activity would reverse this process. Initial shut down would be accomplished by cooling the storage media. This would be made permanent by evacuating the hydrogen from the gas-confining chamber. Residual radioactivity stored in the core would normally be expected to keep the core temperature elevated, ensuring that the core would be emptied first of most of its hydrogen. The reactor is permanently safe from any possible fission activity as soon as enough hydrogen is extracted that what remains cannot moderate the core up to criticality. It should be very easy to extract almost all of the hydrogen in a reasonable length of time, easily satisfying this criterion many times over.

This hydrogen extraction can be accomplished at pressures above ambient by ensuring that the uranium powders are above 430° C. during the extraction procedure. The 430° C. temperature is the dissociation temperature for one atmosphere hydrogen pressure. The positive gauge pressure ensures that no oxygen can leak into the module and generate oxides of the fuel. After the hydrogen has been extracted, the module can then be pressurized with an inert gas, e.g. argon, to ensure a positive overpressure as the module is transported back to the factory.

Fuel Alternatives

This power module can accommodate a variety of fuel compositions. The initial calculations have assumed 5% enriched “reactor grade” uranium. Additionally, the system has been designed based on the physical-chemical properties of uranium. Other combinations of fissile fuels mixed with fertile or non-fissile hydrides will also work. For example, the U²³⁵ can be replaced with plutonium to serve as the fissile element. Plutonium reacts very rapidly with hydrogen making a hydride at room temperature with a very low dissociation pressure compared to uranium hydride. Plutonium's melting temperature is 640° C., which would make the hydride particles fuse together at temperatures that might be as low as 400° C. These low temperatures make PuH₃ much less attractive as a reactor fuel to power a steam generator. However, if plutonium is only a minor constituent, diluted by depleted or natural uranium, it will have only a minor effect on the properties of the combined hydride. At the pure uranium limit of the Pu-U phase diagram, the melting temperature of uranium is reduced approximately 11° C. per 1% of added Pu. A 5% substitution of Pu into metallic uranium only reduces the melting temperature 50° C. to 10750° C. This small change in transition temperature should affect the particle fusion temperature by an equal or less amount. The hydride formed by the mixture of U and Pu may therefore perform essentially identically to that of pure uranium. The possibility of substituting Pu for U²³⁵ in the power module significantly adds to its versatility and commercial attractiveness.

Plutonium produces less than half the fraction of delayed neutrons as uranium, which reduces the margin of safety for controlling the fission reactions if it is used in conventional reactors. Since this reactor is limited in criticality increase by the slow inflow of hydrogen through the powdered fuel, the reduced number of delayed neutrons may no longer be the dominant concern that it has been. As has been presented above, the variations in the neutron multiplier to keep the reactor stable have been, at a maximum, of the order of 10⁻⁴. Since the delayed neutrons coming out of plutonium is 0.003, there is a full order of magnitude margin of safety for the plutonium-burning reactor to be safe and stable. The hydride reactor may prove to be an effective device to burn plutonium, solving one of the nuclear industry's significant problems: what to do with the plutonium that has accumulated since the dawn of the nuclear era. This important niche could make this power module very important for the future of the nuclear industry.

Thorium hydride has physical-chemical properties similar to uranium hydride, but only for part of the hydrogens per molecule. The first two hydrogens bound to a thorium atom (ThH₂) are more tightly bound than the others, up to Th₄H₁₅. This results in a dissociation pressure for hydrogen compositions above ThH₂that is similar to UH₃ but only a fraction of the hydrogens are mobile. Use of thorium hydride would result in greater physical disruption of the powdered fuel as hydrogen escapes to stabilize periods of positive reactivity and slow the return of hydrogen during periods of negative reactivity by increasing the thickness of the powder barrier through which the gas must be forcefully transported. Thorium could be used as the fertile diluent for either fissile uranium or plutonium. Since the transient calculations have predicted that less that one percent of the stored hydrogen need be exchanged to maintain criticality stability, the limit on the fraction of hydrogens in thorium hydride that are mobile should present no significant difficulty. Thorium hydride may ultimately be even more attractive than uranium hydride because separating the fissile components from the fertile components would be a chemical separation instead of an isotopic separation. Furthermore, the fissile product of thorium absorption of a neutron is U²³³, a very attractive fissile fuel for reactors.

Thorium also permits higher temperature operation of the reactor because of its high melting temperature, 1755° C. The higher temperature operation offers the possibility of higher efficiency conversion of the thermal power generated by the reactor to electrical power. The high melting temperature would complicate the zone refining processing of the spent fuel, however, alloys of thorium and uranium would reduce the melting temperature. For a wide range of compositions on the uranium rich side of the phase diagram the melting point of the alloy is a fixed value of 1375° C. On the thorium rich side of the phase diagram, the melting temperature is approximately linear with thorium content from the 1375 to the 1755° C. point for compositions from 50 to 100% thorium.

High Fuel Burnup Performance

Many reactors purposely designed for high stability and particularly designed for unattended operation are constructed on the edge of criticality. The negative feedback that controls them is often either the thermal expansion of the core elements or the thermal heating of the neutrons to take advantage of a negative slope of the fission absorption cross section and the positive slope with energy of resonance absorption of the neutrons by competing nuclei. These devices usually are operationally marginal, assembled only a few percent over the critical mass achievable with the controls optimized. It therefore may not be possible to achieve more than a few percent burnup of the fuel in the reactor. In contrast, the hydride reactor can maintain control of the fission activity for a large excess of fuel, which permits high burnup of the available fuel. Fissile fuel burnup of at least 50% should be achievable with adequate design. The critical parameters for the initial design of the reactor and the point where the reactor finally fails to reach nuclear criticality can be estimated from work detailed in H. C. Paxton, J. T. Thomas, D. Callahan, and E. B. Johnson, “Critical Dimensions of Systems Containing U²³⁵, Pu²³⁹, and U²³³”, Los Alamos Scientific Laboratory and Oak Ridge National Laboratory Report TID-7028 (June 1964), or by using MCNP. To a first order approximation, a 50% burnup requires about twice the minimum amount of fuel and about one half the stoichiometric amount of hydrogen to achieve initial criticality.

Heat Extraction for Practical Applications

For operation in the 500° C. range, potassium is an effective working fluid for heat pipes for the invention. Power extraction requires a thermal gradient but this gradient must be controlled to prevent localized high temperatures that might fuse the powder particles together into larger clumps. The thermal conductivity of the hydride can be estimated from measurements made on hydride based SNAP fuels detailed in Sidney G. Nelson, “High-Temperature Thermal Properties of SNAP-10A Fuel Materiaf”, Battelle Memorial Institute Report 1714 (1965), which gave a conductivity of approximately 0.35 W/cm/° C. The hydrogen gas thermal conductivity is temperature dependent but approximately 1/100 of the hydride value. The combination thermal conductivity is then approximately 0.04 W/cm/° C., for the measured void fraction of 0.32. This thermal conductivity is small but is similar to the 0.05 W/cm/° C. conductivity of UO₂, commonly used in reactor fuel rods, in the same temperature range. Therefore the thermal management of a device according to the invention requires engineering similar to that which has already been developed for present day power reactors. The optimization of the heat pipe geometry is, of course, an important engineering task to manage the temperature gradients for a particular embodiment of the invention.

Continuous Feed Reactor

The preferred nuclear power source of the invention is highly compact. This compact design has many advantages over present-day reactors. It is also possible to expand the size of a reactor based on the uranium hydride fuel and moderator to exploit additional advantages afforded by the properties of this fuel. A larger reactor can be fabricated by any technique that increases the critical mass and volume. The easiest and most advantageous of these include diluting the critical mass with an abundance of heat pipes and/or reducing the level of U²³⁵ enrichment. As this physical size increases, a point will be reached where it is no longer advantageous to ship the module back to the factory for refueling and refurbishment.

If a uranium hydride reactor becomes a fixed installation, the powdered nature of the fuel permits the module to be continuously fuelled. Powder can be added to the top of the core and an equal quantity can be extracted from the bottom. Since it is anticipated that the fuel cycle will be measured in years, the rate of material replacement is quite low. Therefore, while the fuel feed and bleed introduces additional complications into the mechanical design, these additions are minor because of the small quantities of material that must be handled at any time.

Fuel Reprocessing

One of the remarkable advantages of this reactor concept is the novelty of the fuel form. The hydride chemistry essentially does an end run around many of the problems of nuclear fuel reprocessing. At the end of the useful life of the original charge of fuel, the module will be returned to the factory containing an overpressure of inert gas and residual hydrogen. Adding heat to the fuel drives any remaining hydrogen off, leaving uranium metal. This metal can be stripped of its fission product contaminants by simple zone refining. It would be desirable to recycle all actinides so that the waste does not contain many long-lived components. The small fraction of the processed fuel that contains the concentrated waste may require further processing to extract residual actinides to be blended back into the fuel fraction. Reuse of the fuel would require blending in an add-mixture of enriched or otherwise fissile material to bring the fissile component up to the original 5%, reactor grade design level. This reprocessing only required the addition of power to process the fuel, thereby adding nothing new to the waste stream. The fission fragments can be further concentrated if it is economically useful or can be further processed to extract economically valuable radiation sources.

The simplicity of the process and the zone refining equipment makes reprocessing this fuel economically viable. This permits the contaminated but unburned fuel to be recycled, greatly reducing the waste stream and dramatically improving the economics of future nuclear power production. Only the fission fragments mixed with some residual uranium or thorium require permanent disposal.

Volume Enhancement by Deuterium Dilution

Diluting the hydrogen with deuterium may offer some advantages for the system design. The lower effectiveness of deuterium moderation may permit a slightly larger reactor core volume and therefore greater energy storage and operational lifetime of a single load of fuel. Mixtures of single and double atomic weight hydrogen may yield a fine tuning tool for optimizing the control of individual reactors. Changing this ratio over the operational life of a reactor may be a future means for adapting the source to the poisoning effects of fission products, thereby extending the single fuel load operational lifetime.

Volume Enhancement by Use of Non-Spherical Geometries

Non-spherical geometries, e.g., cylindrical, will increase individual reactor module energy content, thereby permitting greater power production and/or reactor lifetime. Irregular geometries with intentional porosity such as excessive cooling channels would also be effective in increasing energy storage. All designs must be constrained to reach criticality only when a previously selected concentration of hydrogen moderator has been dissolved into the uranium.

Temperature Uniformity

The self-stabilizing character of the invention should also prevent the occurrence of localized hot spots within the active volume that might threaten the structural stability of the device. This uniformity can be achieved on a distance scale of the order of the neutron diffusion distance. This diffusion distance can be evaluated using the relationships presented in Glasstone:

L≈1/\sqrt{3ΣₛΣₐ},

where Σₛ and Σₐ are the macroscopic scattering and absorption cross-sections. Using the scattering cross-section and density for hydrogen and the absorption cross-section and density for uranium, the distance is approximately 1.2 centimeters. The contents of the source on a length scale of this magnitude or greater are preferably slaved to a common temperature by the hydrogen absorption/desorption characteristics without any external interference.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A nuclear fission reactor comprising:
a. a core comprising a fissile metal hydride;
b. an atmosphere comprising a hydrogen isotope to which said core is exposed;
c. a non-fissile material that absorbs and desorbs said hydrogen isotope based on temperature;
d. a means for controlling said non-fissile material temperature; and
e. a means for extracting energy produced in said core

2. The nuclear fission reactor of claim 1 wherein said energy extracting means comprises at least one elongated structure containing a flowing nonhydrogenous fluid.

3. The nuclear fission reactor of claim 2 wherein said nonhydrogenous fluid comprises at least one nonhydrogenous liquid metal.

4. The nuclear fission reactor of claim 3 wherein said at least one liquid metal is selected from the group consisting of liquid potassium and liquid sodium.

5. The nuclear fission reactor of claim 2 wherein said at least one elongated structure is configured as a heat pipe.

6. The nuclear fission reactor of claim 2 wherein said nonhydrogenous fluid comprises at least one nonhydrogenous gas.

7. The nuclear fission reactor of claim 6 wherein said nonhydrogenous gas is selected from the group consisting of helium, argon, nitrogen, and carbon dioxide.

8. The nuclear fission reactor of claim 1 wherein said fissile metal hydride comprises fissile uranium hydride.

9. The nuclear fission reactor of claim 1 wherein said core consists essentially of U and UH₃ and intermediate states therebetween.

10. The nuclear fission reactor of claim 1 wherein said atmosphere consists essentially of said hydrogen isotope.

11. The nuclear fission reactor of claim 1 wherein said atmosphere consists essentially of a mixture of deuterium and protium.

12. The nuclear fission reactor of claim 10 wherein said atmosphere includes non-essential reactor byproduct gases.

13. The nuclear fission reactor of claim 12 additionally comprising a gas extraction apparatus for extracting said non-essential reactor byproduct gases.

14. The nuclear fission reactor of claim 13 wherein said gas extraction apparatus comprises at least one gas port in a containment vessel of said nuclear fission reactor.

15. The nuclear fission reactor of claim 1 additionally comprising a hydrogen isotope pressurization apparatus for providing hydrogen isotopes to said nuclear fission reactor.

16. The nuclear fission reactor of claim 15 wherein said hydrogen isotope pressurization apparatus comprises at least one gas port in a containment vessel of said reactor.

17. The nuclear fission reactor of claim 1 additionally comprising a hydrogen isotope extraction apparatus for removing said hydrogen isotopes from said reactor.

18. The nuclear fission reactor of claim 1 wherein said non-fissile material comprises a non-fissile metal hydride.

19. The nuclear fission reactor of claim 18 wherein said non-fissile material comprises a non-fissile uranium hydride.

20. The nuclear fission reactor of claim 19 wherein said non-fissile material consists essentially of U and UH₃ and intermediate states therebetween.

21. The nuclear fission reactor of claim 1 additionally comprising a plurality of trays holding said non-fissile material.

22. The nuclear fission reactor of claim 1 additionally comprising a neutron reflector between said core and said non-fissile material.

23. The nuclear fission reactor of claim 22 wherein said neutron reflector is selected from the group consisting of beryllium and stainless steel.

24. The nuclear fission reactor of claim 1 additionally comprising thermal insulation means between said core and said non-fissile material.

25. The nuclear fission reactor of claim 1 wherein said fissile metal hydride comprises at least one fissile actinide hydride.

26. The nuclear fission reactor of claim 25 wherein said at least one fissile actinide hydride is selected from the group consisting of hydrides of uranium and plutonium.

27. The nuclear fission reactor of claim 25 wherein said core additionally comprises at least one fertile actinide hydride.

28. The nuclear fission reactor of claim 27 wherein said at least one fertile actinide hydride is selected from the group consisting of hydrides of U²³⁸ and Th²³².

29. A nuclear fission reaction method comprising the steps of:
a. providing a nuclear reactor core comprising a fissile metal hydride and a non-fissile hydrogen isotope absorbing and desorbing material within a pressurization vessel;
b. pressurizing said pressurization vessel with an atmosphere comprising at least one hydrogen isotope;
c. increasing said non-fissile hydrogen isotope absorbing and desorbing material temperature to desorb said at least one hydrogen isotope with a concomitant increase in moderation of said nuclear reactor core to establish criticality;
d. establishing criticality of said nuclear reactor core to generate a resultant heat energy; and
e. extracting said resultant heat energy.
